(19) United States
(12) Patent Application Publication
(10) Pub. No.: US 2025/0346511 A1
(43) Pub. Date: Nov. 13, 2025

(54) PROCESS FOR EFFICIENTLY RECLAIMING COPPER AND EDTA LIGANDS FROM Cu-EDTA-CONTAINING WASTEWATER

(71) Applicant: Nanchang Hangkong University, Nanchang City, Jiangxi Province (CN)

(72) Inventors: Yi Mu, Nanchang City, Jiangxi Province (CN); Xinlu Tong, Nanchang City, Jiangxi Province (CN); Jianping Zou, Nanchang City, Jiangxi Province (CN)

(73) Assignee: Nanchang Hangkong University, Nanchang City, Jiangxi Province, OT (CN)

(21) Appl. No.: 18/760,537

(22) Filed: Jul. 1, 2024

(30) Foreign Application Priority Data
May 8, 2024 (CN) 202410561976.X

(51) Int. Cl. C02F 1/70; C02F 1/66; C02F 101/20; C02F 101/38; C02F 103/16

(52) U.S. Cl. CPC C02F 1/705; C02F 1/66; C02F 2101/20; C02F 2101/38; C02F 2103/16; C02F 2301/08

(57) ABSTRACT

Disclosed is a process for efficiently reclaiming copper and EDTA ligands from Cu-ethylene diamine tetraacetic acid (EDTA)-containing wastewater. The process includes: first, the initial pH value of the Cu(II)-EDTA containing wastewater was adjusted to ≥11.0; then proper amounts of formaldehyde and Cu⁰ powder were added into Cu(II)-EDTA containing wastewater; the hydrogen radical (H·) was generated through the Cu⁰-catalyzed HCHO reaction and involved in reductive decomplaxetion of Cu(II)-EDTA, resulting in formation of metallic copper and EDTA ligand; and subsequently, the metallic copper can be easily separated and recovered from wastewater after static settlement, and the recovery efficiency is up to 99.9%. In addition, EDTA ligand is efficiently recovered through acidification of the supernatant (pH=3.0), which dramatically reduce the concentration of total nitrogen in the wastewater.

### REFERENCE TO PRIOR APPLICATION

This application claims priority to Chinese Patent Application 202410561976.X, filed on May 8, 2024, which is incorporated herein by reference.

### TECHNICAL FIELD

The present disclosure relates to the technical field of wastewater treatment in a heavy metal industry, and in particular to a process for efficiently reclaiming copper and ethylene diamine tetraacetic acid (EDTA) ligands from Cu-EDTA-containing wastewater.

### DESCRIPTION OF RELATED ART

In industries involving electroplating, printed circuit boards manufacturing etc., aiming at preventing Cu²⁺ from precipitating, a large amount of ethylene diamine tetraacetic acid (EDTA) is used as ligands to complex Cu²⁺. Therefore, wastewater in the industries involving electroplating, printed circuit boards, etc. has a high level of Cu(II)-EDTA. Being stable in the wastewater and strong in biological toxicity, Cu(II)-EDTA cannot be effectively removed through traditional biochemical methods. In addition, Both China and USA have set stringent emission standards of wastewater from relevant industries, and the maximum allowable emission concentration of copper is 1.0 mg/L. Therefore, it is a pressing issue to find a green and economical method, so as to efficiently remove Cu²⁺ from Cu(II)-EDTA-containing wastewater.

Currently, advanced oxidation processes (AOPs) combined with alkaline precipitation are widely employed for treating Cu(II)-EDTA wastewater. The detailed reaction mechanism is shown as follow. Decomplexation of Cu(II)-EDTA complex for releasing Cu²⁺ ion by hydroxyl radicals (·OH) is the initial step. Then, pH values of the wastewater are adjusted to be alkaline by addition of lime or sodium hydroxide. Finally, free Cu²⁺ reacts with OH⁻ to generate Cu(OH)₂ precipitates. Accordingly, heavy metal and organic substances can be removed from the wastewater through the AOPs combined with alkaline precipitation method. However, the advanced oxidation combined with alkaline precipitation method still has the following shortcomings in treating electroplating wastewater. First, it usually encounters problems such as a long treating process flow, complex manipulation, large investment, large chemical (hydrogen peroxide) consumption, and high operation cost. Second, the elimination of Cu(II) from the Cu(II)-EDTA wastewater using the advanced oxidation combined with alkaline precipitation method generates a large number of Cu-contained hazardous wastes, which will have a risk of causing secondary pollution if it is not improperly disposed. Third, decomplexation efficiency of Cu(II)-EDTA by AOPs is relatively low, it usually takes several weeks to completely decomposition of metal complexes for releasing metal ions. Fourthly, after treatment with the advanced oxidation and alkali-coupled precipitation method, the Cu(II)-EDTA-containing wastewater has an unstable effluent quality, the concentration of Cu²⁺ in effluent may exceed the limit of the emission standard occasionally. Moreover, a membrane separation technology has to be applied, which largely increases the cost. It is clear that the current processing technology is no longer able to satisfy the current increasingly-stringent emission standard. In addition, the valuable metal copper and EDTA ligand cannot be efficiently reclaimed through the current advanced oxidation and alkali-coupled precipitation method, resulting in waste of resources, which is contrary to the concept of green and sustainable development advocated at present.

Aiming at the problems of a high processing cost, undesirable timeliness, an unstable effluent quality, a tendency to cause secondary pollution, incapacity to reclaim metal copper from wastewater, etc., generated when the current advanced oxidation and alkali-coupled precipitation method is used to process Cu(II)-EDTA-containing wastewater, the present disclosure provides an advanced Cu⁰/HCHO reduction technology. Accordingly, Cu(II)-EDTA in wastewater can be efficiently decomplexed, and metal copper and EDTA ligand can be efficiently reclaimed.

### SUMMARY

An objective of the present disclosure is to provide a method for efficiently reclaiming metal copper and EDTA ligand from Cu-ethylene diamine tetraacetic acid (EDTA)-containing complexed wastewater, so as to solve the technical problems in the prior art.

In order to realize the above objective, the present disclosure provides the technical solution as follows:

In a first aspect, a process for efficiently reclaiming copper from Cu-EDTA-containing wastewater is provided. The process specifically includes:
step 1: adding a proper amount of formaldehyde to the Cu-EDTA-containing wastewater to obtain a mixed system;
step 2: adjusting a pH of the mixed system to a designated range;
step 3: adding a proper amount of copper powder to an adjusted mixed system, and catalyzing the formaldehyde to generate hydrogen radicals (H·); and
step 4: involving the in situ generated hydrogen radicals in reductive decomplexation of Cu(II)-EDTA to form metallic copper (Cu⁰) and EDTA ligand, and recycling the metallic copper after static settlement.

Preferably, commercial grade formaldehyde is used in step 1, and the molar ratio of the formaldehyde to Cu(II) is 1:1-1:50.

Preferably, the pH value in step 2 was adjusted to ≥11.0.

Preferably, the amount of copper powder added in step 3 is 0.1 g/L-2.0 g/L, and commercial grade copper powder was preferably added in step 3.

In a second aspect, a process for efficiently reclaiming EDTA ligands from Cu-EDTA-containing wastewater is provided. The process specifically includes:
step 1: adding a proper amount of formaldehyde to the Cu-EDTA-containing wastewater to obtain a mixed system;
step 2: adjusting a pH of the mixed system to a designated range;
step 3: adding a proper amount of copper powder to an adjusted mixed system, and catalyzing the formaldehyde to generate hydrogen radicals;
step 4: involving the in situ generated hydrogen radicals in reductive decomplexation of Cu(II)-EDTA to form metallic copper (Cu⁰) and EDTA ligand, and recycling the metallic copper after static settlement; and
step 5: adjusting a pH of the supernatant to the designated range, resulting in formation of plenty of white precipitate, collecting the precipitates through filtration, and determining the precipitates as high purity of EDTA ligand by FT-IR spectra analysis.

Preferably, commercial grade formaldehyde was added in step 1, and a molar ratio of the formaldehyde to Cu(II) is 1:1-1:50.

Preferably, the pH value in step 2 was adjusted to ≥11.0.

Preferably, the amount of copper powder added in step 3 is 0.1 g/L-2.0 g/L, and commercial grade copper powder was preferably added in step 3.

Preferably, the pH value in step 5 was adjusted to ≤3.0.

The present disclosure has the beneficial effects as follows:
1. According to the present disclosure, the copper and EDTA ligands are reclaimed from the Cu(II)-EDTA-containing wastewater. Target pollutants are reduced and reclaimed from the source, creating desirable conditions for subsequent wastewater processing and up-to-standard emission.
2. The present disclosure is simple to operate, low in operation cost, and capable of realizing practical application readily, and does not require a complex apparatus in a processing process.

### BRIEF DESCRIPTION OF THE DRAWINGS

The accompanying drawings described herein are used for providing further understanding of the present disclosure as a constituent part of the present disclosure. The illustrative examples of the present disclosure and their descriptions serve to explain the present disclosure, instead of limiting the present disclosure improperly.

FIG. 1: a comparison effect graph of removing Cu(II) from Cu(II)-ethylene diamine tetraacetic acid (EDTA) wastewater in Cu⁰, HCHO, and Cu⁰/HCHO systems at an initial pH of 13.0. The initial concentrations of Cu(II)-EDTA, copper powder, and HCHO were 8.0 mM, 1.0 g/L, and 240.0 mM, respectively;

FIG. 2: electron paramagnetic resonance (EPR) spectra of H· generated in the Cu⁰/HCHO systems at an initial pH of 13.0;

FIG. 3: an XRD pattern of the precipitate obtained from Cu(II)-EDTA wastewater after treatment of Cu⁰/HCHO process;

FIG. 4: FT-IR spectra of the EDTA obtained from the liquid supernatant after treatment with acidification;

FIG. 5: removal efficiency of Cu from Cu(II)-EDTA wastewater by Cu⁰/HCHO process at different initial pH values. The initial concentrations of Cu(II)-EDTA, copper powder, and HCHO were 8.0 mM, 1.0 g/L, and 240.0 mM, respectively;

FIG. 6: removal efficiency of Cu in the Cu⁰/HCHO system with various Cu⁰ catalyst concentrations (0.4-1.6 g/L). The initial concentrations of Cu(II)-EDTA and HCHO were 8.0 mM and 240.0 mM, respectively. The initial pH value was 13.0;

FIG. 7: removal efficiency of Cu in the Cu⁰/HCHO system with various molar ratio of Cu(II)-EDTA to HCHO concentration. The initial concentrations of Cu(II)-EDTA and Cu⁰ were 8.0 mM and 1.0 g/L, respectively. The initial pH value was 13.0; and

FIG. 8: effects of different ions on Cu removal from Cu(II)-EDTA wastewater in Cu⁰/HCHO systems. The initial concentrations of Cu(II)-EDTA, Cu⁰, and HCHO were 8.0 mM, 1.0 g/L, and 240.0 mM, respectively.

### DETAILED DESCRIPTION

Specific examples of the present disclosure will be described in detail herein, and preferred examples of the present disclosure are shown in the accompanying drawings. The accompanying drawings are used to supplement the description of the text portion of the description with figures, so that people can intuitively and vividly understand each technical feature and the overall technical solution of the present disclosure, but cannot be interpreted as limiting the scope of protection of the present disclosure.

A process for efficiently reclaiming copper from Cu-ethylene diamine tetraacetic acid (EDTA)-containing wastewater is provided in one preferred example of the present disclosure. The process specifically includes:
step 1: a proper amount of formaldehyde was added to the Cu-EDTA-containing wastewater to obtain a mixed system;
step 2: a pH of the mixed system was adjusted to a designated range;
step 3: a proper amount of copper powder was added to an adjusted mixed system, and the formaldehyde is catalyzed to generate hydrogen radicals; and
step 4: the in situ generated hydrogen radicals was involved in reductive decomplexation of Cu(II)-EDTA to form metallic copper (Cu⁰) and EDTA ligand, and the metallic copper was recycled after static settlement.

In the example, commercial grade formaldehyde was added in step 1, and a molar ratio of the formaldehyde to Cu(II)-EDTA is 1:1-1:50.

In the example, the pH value in step 2 was adjusted to ≥11.0.

In the example, an addition amount of the copper powder in step 3 was 0.1 g/L-2.0 g/L, and commercial grade copper powder was preferably added.

It should be noted that in the example, EDTA was decomposed into nitrogen-containing “secondary pollutants” during oxidation and decomplexation of metal complexes, resulting in a high content of total nitrogen in the wastewater. However, the increasingly-stringent emission standard of total nitrogen in wastewater has brought new environmental protection pressure to relevant enterprises. In view of the above, a process for efficiently reclaiming EDTA ligand from Cu-EDTA-containing wastewater is provided in another preferred example of the present disclosure. The process specifically includes:
step 1: a proper amount of formaldehyde was added to the Cu-EDTA-containing wastewater to obtain a mixed system;
step 2: a pH of the mixed system was adjusted to a designated range;
step 3: a proper amount of copper powder was added to an adjusted mixed system, and the formaldehyde was catalyzed to generate hydrogen radicals;
step 4: the in situ generated hydrogen radicals was involved in reductive decomplexation of Cu(II)-EDTA to form metallic copper (Cu⁰) and EDTA ligand, and the metallic copper was recycled after static settlement; and
step 5: a pH of the supernatant was adjusted to the designated range, resulting in formation of plenty of white precipitate, and the precipitates were collected through filtration, and determined as high purity of EDTA ligand by FT-IR spectra analysis.

In the example, commercial grade formaldehyde was added in step 1, and a molar ratio of the formaldehyde to Cu(II) is 1:1-1:50.

In the example, the designated range in step 2 is a pH greater than or equal to 11.0.

In the example, an addition amount of the copper powder in step 3 is 0.1 g/L-2.0 g/L, and commercial grade copper powder is preferably added.

In the example, the designated range in step 5 is a pH smaller than or equal to 3.0.

The technical principles of the present disclosure are as follows:
(1) Cu(II)-EDTA, characterized by its stable chelating structure, high solubility, mobility, and potential for bioaccumulation in aquatic ecosystems, renders traditional heavy metal treatment methods such as adsorption, chemical precipitation, and ion exchange less effective. It is found that the copper powder can catalyze the formaldehyde, a type of cheap industrial raw material, to form formic acid and hydrogen radicals (i.e. a Tishchenko reaction) under an alkaline condition. The in-situ generated H· radicals can thermodynamically reduce Cu(II) of Cu(II)-EDTA into the metallic state Cu⁰ due to its high reduction potential (E⁰(H⁺/H·)=−2.42 V vs. RHE). In addition, the central Cu(II) becomes more exposed and liable to be attacked by H· radicals because some [EDTA-Cu(II)-OH-]³⁻ appears at alkaline pH and the insertion of coordinated OH-stretches the coordination bonds. Therefore, alkaline Cu⁰/HCHO system is an efficient method for reductive decomplexation of Cu(II)-EDTA to form copper metal and EDTA ligand, and the copper metal can be easily separated and recycled from the metal-complexed wastewater after static settlement.
(2) In contrast to current oxidative strategies, this reductive strategy is a mild and rapid decomplexation process that does not damage the chelating EDTA ligand. The solubility of EDTA in water is related to its existing form. Under the alkaline condition, most EDTA exists as ionic Y⁴⁻, with a high solubility (S=11.1 g/L). While EDTA is poorly soluble in acidic conditions, and it would be precipitated as its protonated form (H₄Y, S<0.1 g/L). Therefore, the EDTA ligand in the wastewater can be recovered in the form of insoluble protonated EDTA (H₄EDTA, S≤0.1 g/L at 20° C.) by lowering the solution pH≤3.0, thus avoiding the generation of intractable N-containing pollutants. The experimental results indicated that a plenty of white precipitates occurred when the pH values of supernatant was adjusted to 3.0, the white precipitates were collected through filtration, and determined as high purity of EDTA ligand by FT-IR spectra analysis. Besides, the recovery of EDTA ligand will significantly decrease the concentration of total nitrogen (TN). Obviously, the recovery of Cu and EDTA ligand will significantly improve the biochemical capability of the solution, making the combination of present disclosure with biodegradation methods favorable for further decreasing COD and TN content. The present disclosure is simple to operate, low in operation cost, and capable of realizing practical application readily, and does not require a complex apparatus in a processing process.

### Example 1

In the present disclosure, the concentration of Cu(II)-EDTA in the simulated wastewater waters was 8.0 mM (Cu(II): 508.0 mg/L) and the values for Cu(II)-EDTA concentration was based on the reported concentrations in actual electroless copper plating wastewater. The batch experiments for removal of Cu(II) from the wastewater were performed in the 200.0 ml conical flask containing 100.0 mL of 8.0 mM Cu(II)-EDTA stock solution. The pH values of the solutions were adjusted to predetermined values (pH=13.0) with the addition of 10.0 M NaOH. Subsequently, 0.1 g of copper powder ([Cu]₀=1.0 g/L) and 1.8 mL of 37.0 wt. % HCHO solution ([HCHO]₀=240 mM) were added into Cu(II)-EDTA stock solution. The conical flask was then transferred into a shaker (100 r·min⁻¹) immediately to initiate the reaction. At regular time intervals (0 h, 1 h, 3 h, 5 h, 7 h, and 9 h), 1.0 mL of treated solution was sampled and filtered with a 0.22 μm nylon filter for subsequent measurement of Cu ion. All the experiments were repeated at least three times.

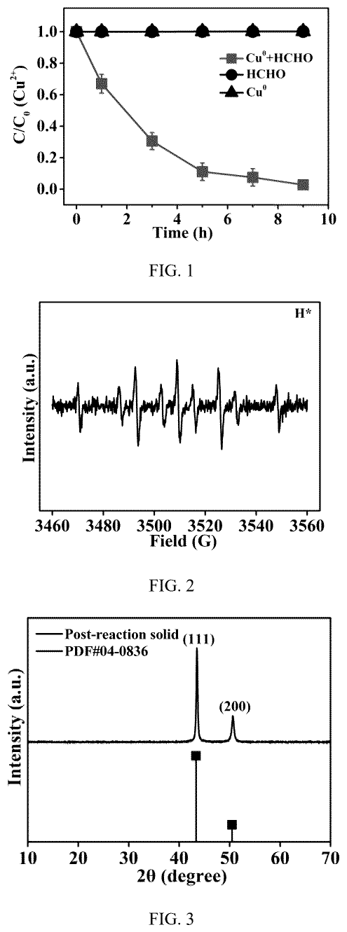

The experimental results are as shown in FIG. 1. Negligible Cu is removed when only Cu powder or formaldehyde (HCHO) was used. In contrast, 99.9% of Cu is removed within 9 h in the Cu⁰/HCHO system at pH=13.0, and the Cu ion concentration is decreased to the value below the detection limit (<0.01 mg/L) within 10 h. After the treatment, the brown precipitate was finally collected after static settlement. As shown in FIG. 2, the brown precipitate is identified as high purity of Cu⁰ by XRD analysis. These results show that Cu(II) of Cu(II)-EDTA can be efficiently reduced into Cu⁰ by alkaline Cu⁰/HCHO process, following which the Cu⁰ can be easily separated and recycled from the metal-complexed wastewater. The copper recovery efficiency (n) is calculated to be 99.9% according to follow equation:

η=(m₁−m₀)/(C₀×V×Mr)×100% (1)
where m₀ and m₁ (mg) are the initial and final mass of the copper powder in the Cu⁰/HCHO system, C₀ (mM) is the initial molar concentration of Cu(II)-EDTA, Vis the volume of the reaction solution, Mr is the relative molecular mass of Cu(63.5 g/mol).

To understand how the Cu0/HCHO process induces the reductive decomplexation of Cu(II)-EDTA and enables the recycling of Cu, electron paramagnetic resonance (EPR) trapping measurement with the assistance of 5,5-dimethyl-1-pyrroline N-oxide (DMPO) as the spin-trapping agent was utilized to detect the generated reactive species in the Cu⁰/HCHO process. As shown in FIG. 3, a nine-line EPR signal (intensity ratio of the nine peaks is 1:1:2:1:2:1:2:1:1, α_{N}=16.7 G, α_{β}^{H}=22.5 G) is observed in the Cu⁰/HCHO system (pH=13.0). This signal is assigned to DMPO-H· adduct, fully confirming the formation of H· in the Cu⁰/HCHO system.

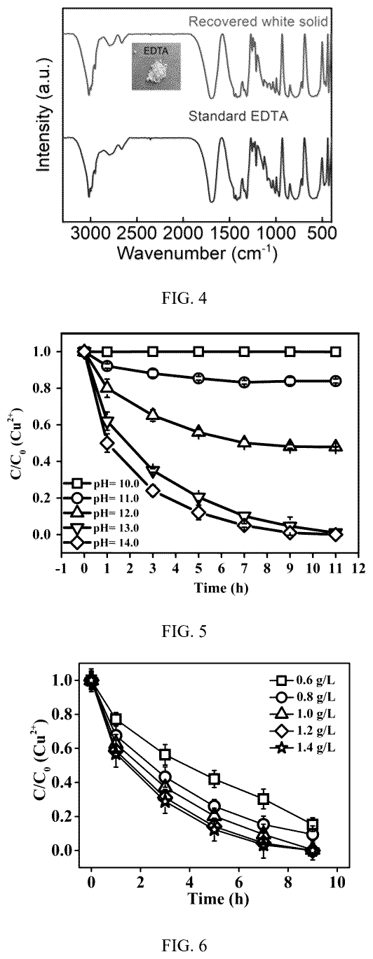

In contrast to the aggressive oxidative strategies, this reductive decomplexation method is a mild process that can efficiently recycle copper without the decomposition of EDTA ligand. Subsequently, the supernatant was acidified to pH 3.0 with H₂SO₄, and substantial EDTA precipitates occurred. FT-IR spectroscopy was employed to characterize the recovered EDTA after multiple cycles of washing, filtration, and drying. As exhibited in FIG. 4, the FT-IR spectra of the recovered EDTA and fresh EDTA are identical. Thus, the white precipitates is confirmed as the high purity of EDTA ligand. The EDTA recovery efficiency (n) is calculated to be 97.0% according to follow equation:

η=m/(C₀×V×Mr)×100% (1)
where m is the mass of the EDTA ligand recycled from the supernatant after treatment with acidification, C₀ (mM) is the initial molar concentration of Cu(II)-EDTA, Vis the volume of the reaction solution, Mr is the relative molecular mass of EDTA (292.2 g/mol).

### Example 2

The pH values of the solutions were adjusted to predetermined values (10.0, 11.0, 12.0, 13.0, and 14.0) with the addition of NaOH (10 mol/L) and H₂SO₄ (10 mol/L). Other experimental conditions are the same as those in Example 1. As shown in FIG. 5, when the pH of the solution is increased from 10.0 to 13.0, the Cu removal efficiencies increase significantly. However, Cu removal efficiencies don't increased obviously when the initial pH value is further increased to 14.0. Therefore, considering efficiency and cost, pH=13.0 is chosen as optimum pH value to recycle Cu from Cu(II)-EDTA wastewater in the Cu⁰/HCHO system.

### Example 3

Under a preferred condition of an initial pH of 13.0, the initial concentration of Cu⁰ catalyst was increased from 0.6 g/L to 1.4 g/L, other experimental conditions are the same as those in Example 1. As shown in FIG. 6, when initial concentration of Cu⁰ catalyst is increased from 0.40 g/L to 1.0 g/L, the Cu removal efficiencies increased significantly. However, Cu removal efficiencies don't increased obviously when initial concentration of Cu⁰ catalyst is further increased to 1.2 g/L and 1.6 g/L. Therefore, considering efficiency and cost, 1.0 g/L is chosen as optimum initial concentration of Cu⁰ catalyst to recycle Cu from Cu(II)-EDTA wastewater in the Cu⁰/HCHO system.

### Example 4

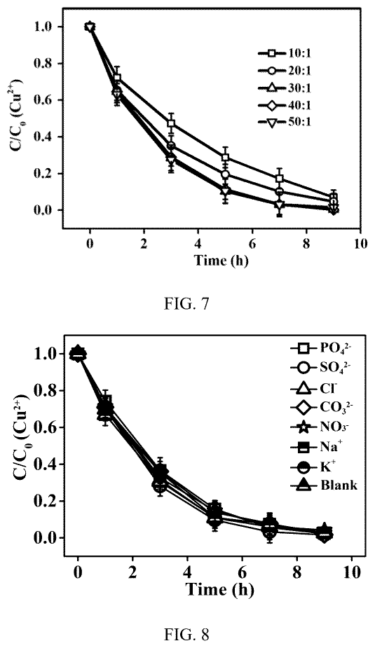

Under a preferred condition of an initial pH of 13.0 and initial Cu⁰ catalyst of 1.0 g/L, the initial concentration of Cu(II)-EDTA is fixed at 8.0 mM, the molar ratios of HCHO to Cu(II)-EDTA were set at 10:1, 20:1, 30:1, 40:1, and 50:1, other experimental conditions are the same as those in Example 1. As shown in FIG. 7, when the molar ratios of HCHO to Cu(II)-EDTA is increased from 10:1 to 30:1, the Cu removal efficiencies increased significantly. However, Cu removal efficiencies are not increased obviously when increasing the HCHO to Cu(II)-EDTA molar ratio from 30:1 to 50:1, Therefore, considering efficiency and cost, 30:1 is chosen as the optimal HCHO to Cu(II)-EDTA molar ratio to recycle Cu from Cu(II)-EDTA wastewater in the Cu⁰/HCHO system.

### Example 5

Under a preferred condition: [Cu(II)-EDTA]₀=8 mM, [Cu⁰]₀=1.0 g/L, [HCHO]₀=240 mM, and initial pH=13.0, the interference of commonly co-existing ions (such as Cl⁻, CO₃²⁻, SO₄²⁻, PO₅³⁻, NO₃⁻, Na⁺, K⁺) on the Cu removal from the Cu(II)-EDTA wastewaters was discussed. The initial concentrations of the co-existing ions were 1 mM. As shown in FIG. 8, the coexisting components are almost invalid on Cu removal. This phenomenon can be ascribed to the reactions between the co-existing ions with reactive species being kinetically inefficient. Thus, the Cu⁰/HCHO process is considered to have a strong adaptability to wastewater with complex water quality conditions.

According to the present disclosure, a Cu⁰/HCHO process is proposed to reductively decomplex Cu(II)-EDTA to form metallic Cu product and EDTA ligand. The Cu and EDTA recovery efficiency is up to 99.9% and 97%, respectively. In conclusion, this method is a green, facile and cost-effective method for remediation of Cu(II)-EDTA containing wastewater, and it has a broad application prospect in treating authentic copper electroplating wastewater.

A person skilled in the art can combine and superimpose the additional technical features at random without conflicts.

What are described above are merely preferred embodiments of the present disclosure. The technical solutions that realize the objective of the present disclosure through basically the same means or by changing the use amounts of reaction reagents fall within the scope of protection of the present disclosure.

What is claimed is:

1. A process for efficiently reclaiming copper from Cu-ethylene diamine tetraacetic acid (EDTA)-containing wastewater, specifically comprising:
step 1: adding a proper amount of formaldehyde to the Cu-EDTA-containing wastewater to obtain a mixed system;
step 2: adjusting a pH of the mixed system to a designated range;
step 3: adding a proper amount of copper powder to an adjusted mixed system, and catalyzing the formaldehyde to generate hydrogen radicals; and
step 4: involving the in situ generated hydrogen radicals in reductive decomplexation of Cu(II)-EDTA to form metallic copper (Cu⁰) and EDTA ligand, and recycling the metallic copper after static settlement.

2. The process for efficiently reclaiming copper from Cu-EDTA-containing wastewater according to claim 1, wherein commercial grade formaldehyde is added in step 1, and a molar ratio of the formaldehyde to Cu(II) is 1:1-1:50.

3. The process for efficiently reclaiming copper from Cu-EDTA-containing wastewater according to claim 1, wherein the designated range in step 2 is a pH greater than or equal to 11.0.

4. The process for efficiently reclaiming copper from Cu-EDTA-containing wastewater according to claim 1, wherein an addition amount of the copper powder in step 3 is 0.1 g/L-2.0 g/L.

5. A process for efficiently reclaiming EDTA ligands from Cu-EDTA-containing wastewater, specifically comprising:
step 1: adding a proper amount of formaldehyde to the Cu-EDTA-containing wastewater to obtain a mixed system;
step 2: adjusting a pH of the mixed system to a designated range;
step 3: adding a proper amount of copper powder to an adjusted mixed system, and catalyzing the formaldehyde to generate hydrogen radicals;
step 4: involving the in situ generated hydrogen radicals in reductive decomplexation of Cu(II)-EDTA to form metallic copper (Cu⁰) and EDTA ligand, and recycling the metallic copper was recycled after static settlement; and
step 5: adjusting a pH of the supernatant to the designated range, resulting in formation of plenty of white precipitate, collecting the precipitates were collected through filtration, and determining the precipitates as high purity of EDTA ligand by FT-IR spectra analysis.

6. The process for efficiently reclaiming EDTA ligands from Cu-EDTA-containing wastewater according to claim 5, wherein the designated range in step 5 is a pH smaller than or equal to 3.0.
